(19) United States
(12) Patent Application Publication
(10) Pub. No.: US 2014/0019429 A1
(43) Pub. Date: Jan. 16, 2014

(54) DOWNTIME REDUCTION FOR LIFECYCLE MANAGEMENT EVENTS

(71) Applicants: Volker Driesen, Walldorf (DE); Thomas Vogt, Neustadt a.d.W (DE); Martin Mayer, Heidelberg (DE); Andrey Engelko, Karlsruhe (DE)

(72) Inventors: Volker Driesen, Walldorf (DE); Thomas Vogt, Neustadt a.d.W (DE); Martin Mayer, Heidelberg (DE); Andrey Engelko, Karlsruhe (DE)

(21) Appl. No.: 13/547,793

(22) Filed: Jul. 12, 2012

(51) Int. Cl. G06F 7/00; G06F 17/30

(52) U.S. Cl. 707/703; 707/E17.005; 707/E17.032

(57) ABSTRACT

Extensions to an application programming framework, such as for example a database system, can allow individual parts of an application to be set to “read-only” during a lifecycle management event affecting the application programming framework. The application data for a newly deployed software version can thereby be adjusted without risk of inconsistencies due to parallel use by end-users. However, end-users can continue to work with the remaining application programming framework and even use certain parts of the application programming framework and underlying data in a “read-only” while these parts are currently under reconstruction as part of the lifecycle management event.

### TECHNICAL FIELD

The subject matter described herein relates to lifecycle management events, which can include, but are not limited to deployments of software changes in software architectures such as business software architectures.

### BACKGROUND

The deployment of software changes to one or more applications or application servers, for example one or more applications or application servers providing one or more features or functions of a software architecture, generally causes downtime during which the features and functions provided by the one or more applications or application servers are unavailable. An illustrative but non-limiting example of a software architecture includes a business software architecture such as an enterprise resource planning application or system, which can in some examples be based on a programming language such as the Advanced Business Application Programming language (ABAP) (available from SAP AG of Walldorf, Germany), Java (available from Oracle Corporation. of Redwood City, Calif.), and the like. The downtime occurring during a software deployment in such an architecture can result from storage of data, software, and configuration data (e.g. metadata) in the database. Software changes can include changes to configuration data and database structures and can execute adjustments to data created by a customer organization that uses the one or more applications or application servers as part of day to day use of a software architecture or the like.

### SUMMARY

As part of an initiation of a lifecycle management event to a database system running on at least one application server, a pre-lock for a part of the database system affected by the lifecycle management event can be set such that access to transactions relating to the affected part of the database system is restricted. In this manner, data displayed in a user interface and associated with the affected part of the database system are made read-only with respect to new transactions commencing after the setting of the pre-lock, while completion of one or more in-progress transactions commenced but not completed prior to the setting of the pre-lock is allowed during a grace period of a pre-defined duration. After expiration of the grace period, a final lock imposing a write lock on the affected part of the database system can be set on the affected part of the database system. The pre-lock and the final lock can be removed after completion of activities of the lifecycle event that relate to the affected part of the database system such that productive use of the database system can resume.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating aspects of an example of a software architecture showing features consistent with implementations of the current subject matter;

FIG. 2 is a diagram illustrating aspects of another example of a software architecture showing features consistent with implementations of the current subject matter;

FIG. 3 is a diagram illustrating aspects of a repository showing features consistent with implementations of the current subject matter;

FIG. 4 is a diagram illustrating aspects of an example of a software architecture showing features consistent with implementations of the current subject matter; and

FIG. 5 is a process flow diagram illustrating aspects of a method having one or more features consistent with implementations of the current subject matter;

When practical, similar reference numbers denote similar structures, features, or elements.

### DETAILED DESCRIPTION

Changes in a database performed during a software deployment process can typically be accomplished via several database transactions. This is mainly due to need in many database systems to auto-commit database structure definitions or change statements as part of a structure change. Such database structure definitions or change statements can, for example, include statements or commands passed using the Database Definition Language (DDL) or the like. Since the software fitting the new database structure is typically deployed in another (or several other) transactions, the system can be inconsistent during the deployment process. The software change can be brought in fragments into the system and the system is generally consistent only after all fragments are deployed. To avoid effects that such inconsistencies can cause in operation of an application, application server, software architecture, etc., a “downtime” can be set for the period of the software deployment. In conventional systems, generally only the full application can be set to “offline,” even if only some portion of the data or metadata associated with the application or application server is affected by the deployment.

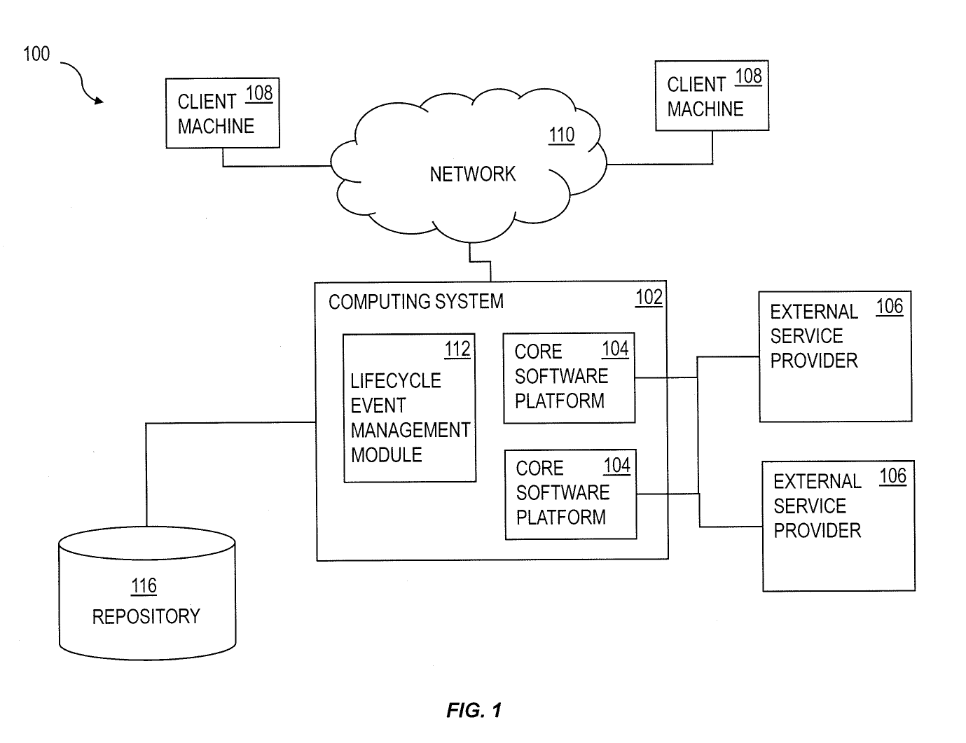

The core software platform of an enterprise resource planning (ERP) system, other business software architecture, or other database functionality can in some implementations be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available business software solution to work with organization-specific business processes and functions is feasible. FIG. 1 shows a diagram of a system consistent with such an implementation. A computing system 102 (also referred to as an application server) can include one or more core software platform modules 104 providing one or more features of the business software system. In some implementations, the computing system 102 can be an application server. The computing system 102 can also aggregate or otherwise provide a gateway via which users can access functionality provided by one or more external service providers 106. Examples of external service providers 106 can include one or more computing systems supporting database functionality or other software functionality created or provided from a partner or other third party software developer. This external service provider database functionality or other software functionality can be provided over either direct or networked connections if the one or more external provider computing systems are separate from the computing system 102 that includes one or more core software platform modules 104. Alternatively, the external service provider database functionality or other software functionality can be hosted on the computing system 102 that includes the one or more core software platform modules 104.

Client machines 108 can access the computing system, either via a direct connection, a local terminal, or over a network 110 (e.g. a local area network, a wide area network, a wireless network, the Internet, or the like). A lifecycle event management module 112 or multiple such modules can execute on the computing system 102, on one or more separate systems, or any combination thereof to perform one or more of the lifecycle event management operations discussed in greater detail below.

The computing system 102 can include or otherwise be provided with access over a direct or networked connection to one or more repositories 116 that can retain one or more of metadata for use by at least one of the one or more core software platform modules 104 and the database functionality or other software functionality provided by one or more external service providers 106. The one or more repositories 116 can store objects or other elements, such as for example business objects, metadata objects, or the like. As used herein, the term business object refers to a set of data that has a meaning, context, other semantic definition, or the like associated therewith. As an example, in a business software architecture, a business object can include a representation of a sales order or sales order process, a representation of a payment or payment process or other business process or a part of a business process, or the like.

These objects or other elements stored in the one or more repositories can include definitions of business scenarios, business processes, and one or more business configurations as well as data, metadata, master data, etc. relating to definitions of the business scenarios, business processes, and one or more business configurations, and/or concrete instances of the data objects (e.g. business objects) that are relevant to a specific instance of the business scenario or a business process. In some implementations, a business object or other metadata object can include a template definition of a standard business process or other related functionality. The template definition can optionally be modified via one or more extensions that can also be stored in the one or more repositories 116. The one or more repositories can also include storage for data relating to the business or other aspects of the organization.

Smaller organizations can also benefit from use of business software functionality. However, such an organization may lack the necessary hardware resources, IT support, and/or consulting budget necessary to make use of a standalone business software architecture product and can in some cases be more effectively served by a software as a service (SaaS) arrangement in which the business software system architecture is hosted on computing hardware such as servers and data repositories that are maintained remotely from the organization's location and accessed by authorized users at the organization via a thin client, such as for example a web browser, over a network.

In a software delivery configuration in which services of an business software system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

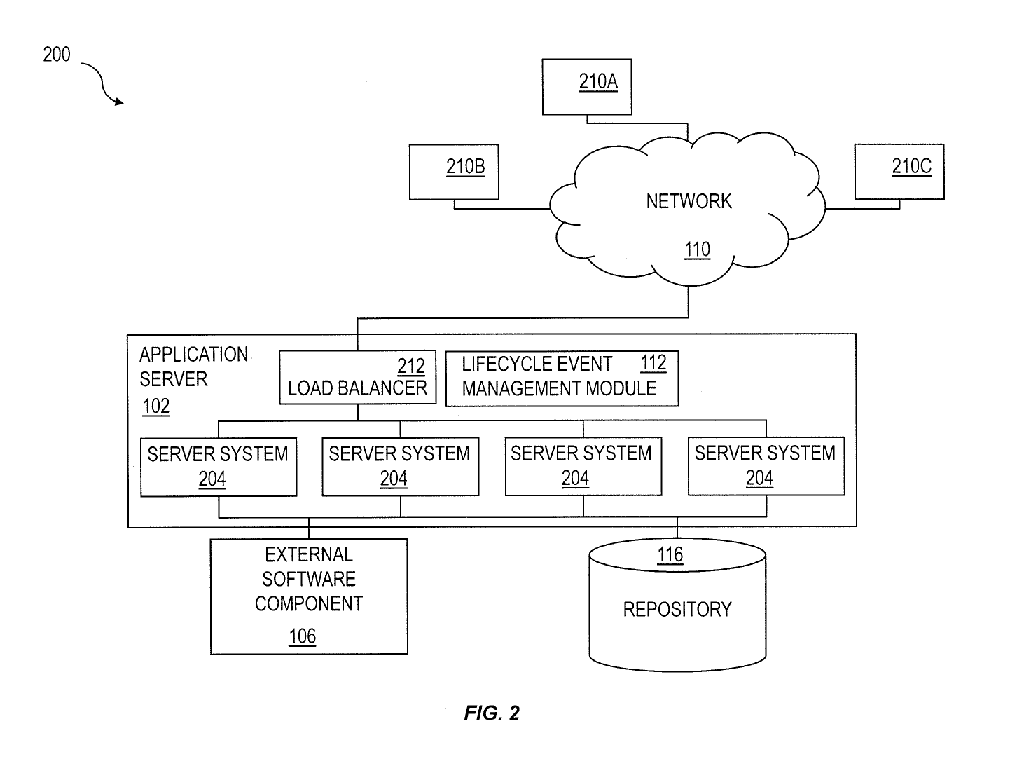

FIG. 2 shows a block diagram of a multi-tenant implementation of a software delivery architecture 200 that includes an application server 102 (also referred to as a computing system), which can in some implementations include multiple server systems 204 that are accessible over a network 110 from client machines operated by users at each of multiple organizations 210A-210C (referred to herein as “tenants” of a multi-tenant system) supported by a single software delivery architecture 200. For a system in which the application server 102 includes multiple server systems 204, the application server can include a load balancer 212 to distribute requests and actions from users at the one or more organizations 210A-210C to the one or more server systems 204. Instances of the core software platform 104 (not shown in FIG. 2) can be executed in a distributed manner across the server systems 204. A user can access the software delivery architecture across the network using a thin client, such as for example a web browser or the like, or other portal software running on a client machine. The application server 102 can access data and data objects stored in one or more repositories 116 which can make one or more of metadata and other data available for use by at least one of the one or more core software platform modules 104 and the database functionality or other software functionality provided by one or more external service providers 106. The application server 102 can also serve as a middleware component via which access is provided to one or more external software components 106 that can be provided by third party developers. A lifecycle event management module 112 or multiple such modules can execute on the application server 102, on one or more separate application servers, or any combination thereof to perform one or more of the lifecycle event management operations discussed in greater detail below.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 102 that includes multiple server systems 204 that handle processing loads distributed by a load balancer 212. Potential benefits from such an arrangement can include, but are not limited to, high and reliably continuous application server availability and minimization of unplanned downtime, phased updating of the multiple server systems 204 to permit continuous availability (one server system 204 can be taken offline while the other systems continue to provide services via the load balancer 212), scalability via addition or removal of a server system 204 that is accessed via the load balancer 212, and de-coupled life cycle events or processes (such as for example system maintenance, software upgrades, etc.) that enable updating of the core software independently of tenant-specific customizations implemented by individual tenants.

As in the example illustrated in FIG. 1, the repository 116 can store a business object that represents a template definition of a standard business process. Each individual tenant 210A-210C can customize that standard template according to the individual business process features specific to business of the organization to which that tenant is assigned. Customizations can be stored as extensions in the one or more repositories 116.

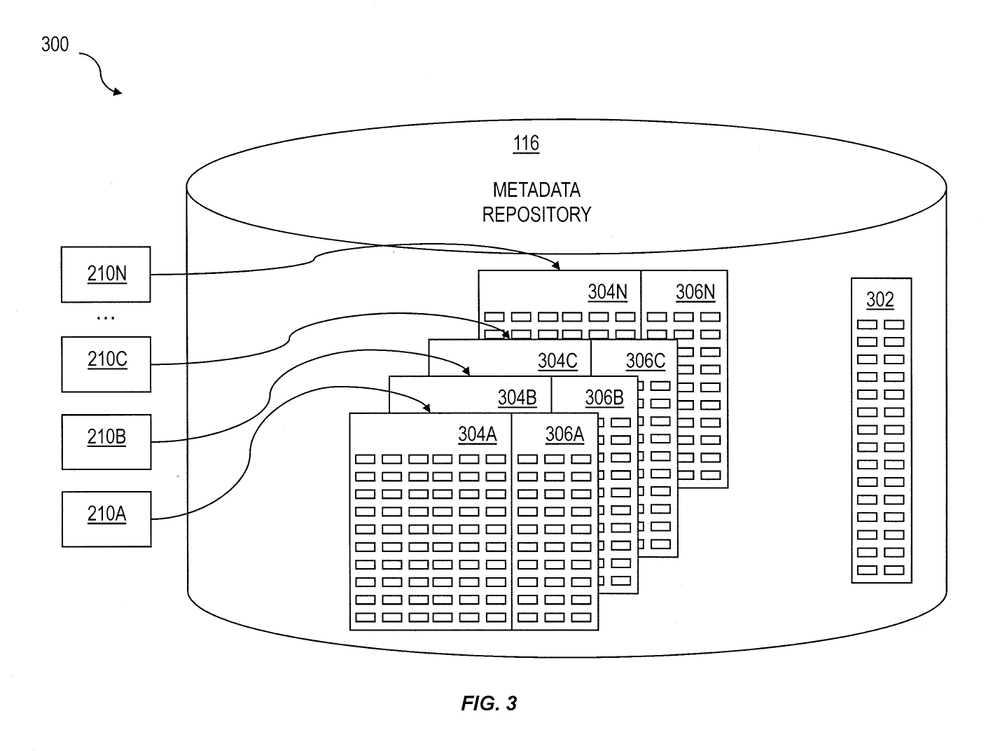

To provide for customization of the business process for each of multiple organizations supported by a single software delivery architecture 200, the data and data objects stored in the one or more repositories 116 and/or other data repositories that are accessed by the application server 102 can include three types of content as shown in FIG. 3: core software platform content 302 (e.g. a standard definition of a business process), system content 304, and tenant content 306. Core software platform content 302 includes content that represents core functionality and is not modifiable by a tenant. System content 304 can in some examples be created by the runtime of the core software platform and can include core data objects that store concrete data associated with specific instances of a given business process and that are modifiable with data provided by each tenant. Metadata relating to one or more of core software platform content 302, system content 304, and content provided by the one or more external service providers 106 can optionally be part of a system tenant that is accessible from all other tenants 210A-210N.

The data and/or the metadata retained in the tenant content 306 can be tenant-specific: for example, each tenant 210A-210N can store information about its own inventory, sales orders, etc. as well as metadata pertaining to extensions, processes, or the like that are specific to the organization assigned to that tenant. Tenant content 306A-306N can therefore include data objects or extensions to other data objects that are customized for one specific tenant 210A-210N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 306 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 302 and system content 304 and tenant content 306 of a specific tenant are accessed to provide the business process definition and/or the status information relating to a specific instance of the business process according to customizations and business data of that tenant such that each tenant is provided access to a customized solution whose data are available only to users from that tenant.

One or more life cycle events or processes of an application server 102 can cause invalidation of the metadata retained in a buffer 112. A life cycle event in this context can refer to one or more of an import, an upgrade, a hot fix, or the like of one or more business objects or other data objects into a core software platform module 104 of a business software architecture or the database functionality or other software functionality provided by one or more external service providers 106. In the example of a multi-tenant approach such as described above in reference to FIG. 2 and FIG. 3, life cycle events affecting features of one or more core software platform modules 104 or of database functionality or other software functionality provided by one or more external service providers 106 can be performed in the system tenant. Similarly, other life cycle events that affect multiple tenants (e.g. scalable add-ons that can be active in multiple tenants) can also be performed on the system tenant. Life cycle events that affect only one tenant, for example upgrading, importing, hot fixing, etc. of an add-on or other custom feature that is used by only a single customer of the business software architecture; switching on or of a scalable add-on functionality for a single tenant; creating or modifying an extension to core software platform content 302, system content 304, or database functionality or other software functionality provided by one or more external service providers 106; or the like can be implemented only in the affected tenant.

In addition to the software deployment scenario discussed above, the migration of a database management system or other business software system to new hardware or the copying of such a system from one application server system to another can also cause downtime as can the migration or copying of one or more tenants of a multi-tenant architecture, such as for example one having features in common with the architectures shown in FIG. 2 and FIG. 3 (explained in greater detail below) from one application server system to another. The resulting downtime can generally be caused by the requirement that the target system must be logically consistent and inclusive of all data from the source system. In conventional approaches, this requirement is generally met by switching the entire source system into a “downtime” state during the migration procedure (or at least some part of it). Otherwise, any data added, deleted, changed, or otherwise affected in the source system during the migration process can be lost in the target system.

Implementations of the current subject matter can provide one or more beneficial features that represent an improvement over conventional approaches to software deployment, tenant or system migration or copying, or other lifecycle management events that can significantly reduce the period of time during which a system is offline or otherwise in “downtime” during such lifecycle events.

In some implementations, a determination can be made for one or more software change packages regarding which database structures or software is to be changed upon execution of the software change package. As an example, upon identifying one or more of migration programs that structurally and semantically change the application data, this determination can include specifying which database tables are affected and also identifying, at the beginning of the migration, the database tables that can be locked and migrated during system uptime without causing a noticeable impact on the business operation or other functionality of the application, application server, business architecture, or the like (hereinafter generically referred to as “the database system”). While it is not difficult to set database tables to a read-only state using conventional database mechanisms, applications using the database tables might print error messages, create data dumps or other system malfunctions, and otherwise behave in a manner that is not “user friendly.” Most users would consider such a system state as “erroneous” or otherwise indicative of a problem.

Implementations of the current subject can include one or more extensions to application programming frameworks to enable generically setting of one or more small, discrete parts of a database system to a “read-only” state while other parts of the application or other parts of the database system continue to operate normally at least for some period of time during a lifecycle management event. For the purposes of this disclosure, “parts of a database system” should be understood to refer to one or more of data, data objects, tables, user interfaces, business objects, or the like—effectively any unit of data or metadata, a data container, or a metadata container. An approach including one or more features consistent with implementations of the current subject matter can allow adjustment of application data for a new software version (or other lifecycle management event) without risk of inconsistencies due to parallel use by end-users while also allowing end-users to continue to work with the remaining (e.g. the non-locked, or otherwise not affected by the lifecycle management event) parts of the database system. Users can also be allowed to continue to use the read-only parts of the database system, which are currently affected by the changes associated with the lifecycle management event. However, due to the read-only lock, no changes can be made to those parts of the database system. Features discussed herein in relation to implementations of the current subject matter can also realize benefits in a migration scenarios based on a “bulk” copy method. For example using special hardware or database specific features it can be useful to lock everything leaving the system in a read-only state.

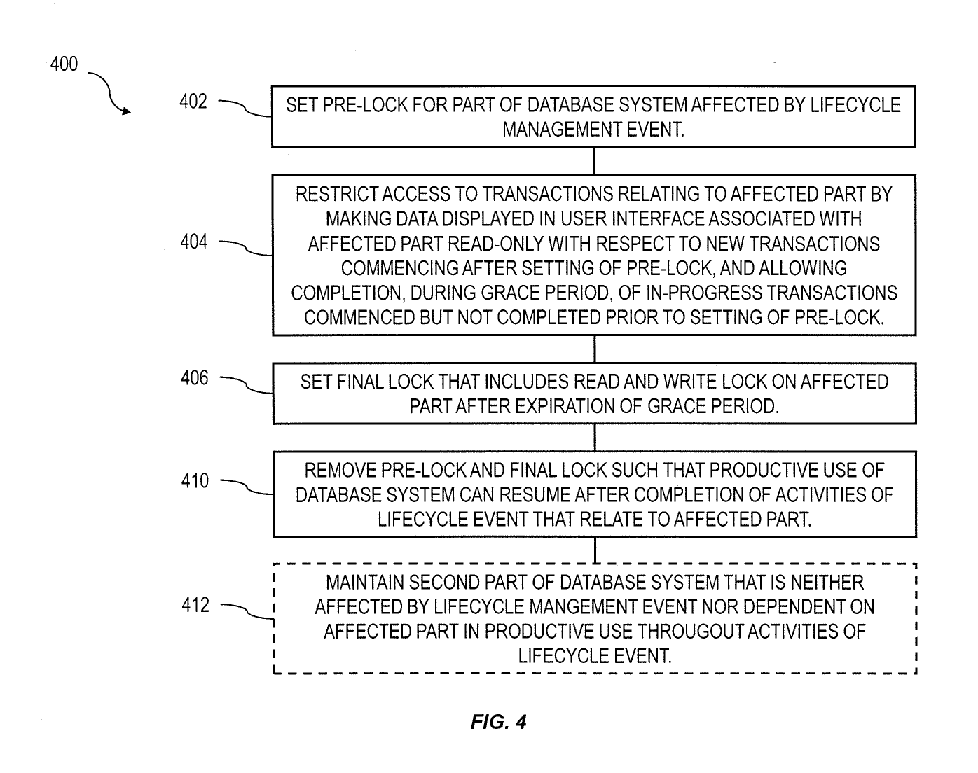

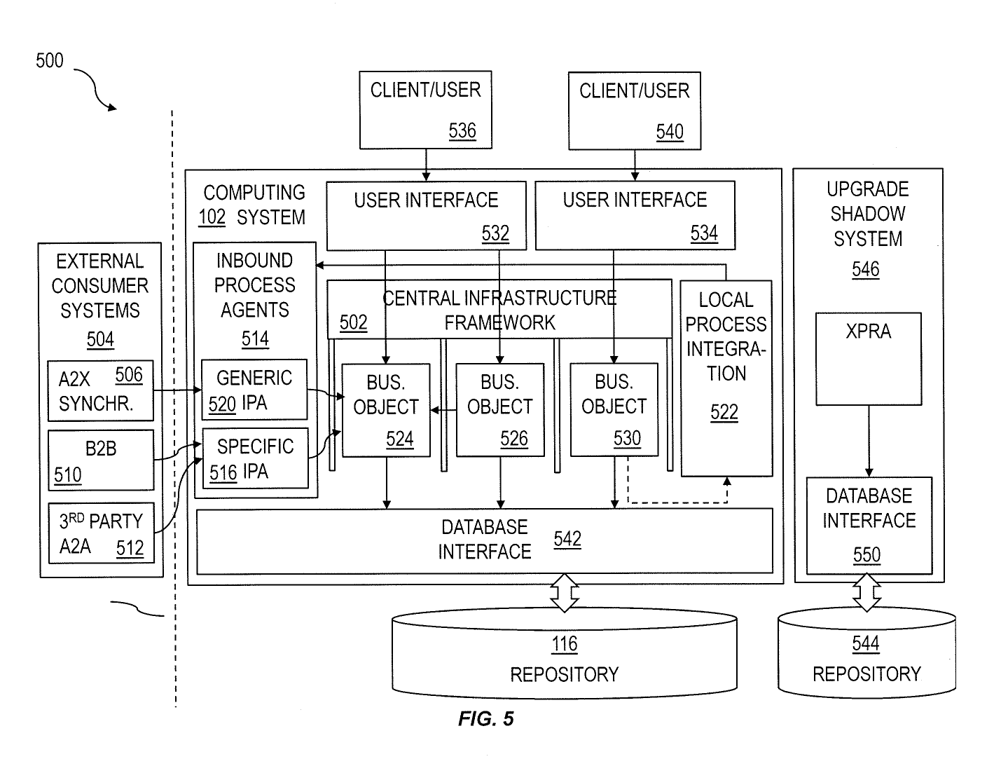

Consistent with one or more implementations of the current subject matter, a lifecycle management event, which can include a deployment of a software change or other aspects of database system management affecting one or more parts of a database system such as are described above, can be initiated using metadata deployed into the system, for example into a repository 116. FIG. 4 shows a process flow chart 400 illustrating features of a method that can be present in implementations of the current subject matter. These metadata can be deployed as part of the lifecycle management event, and can include definitions of the parts of the database system that are affected by the lifecycle management event. A pre-lock can be set for these affected parts of the database system as shown at 402 while leaving at least one unaffected part of the database system available for productive use. The pre-lock can be performed by a central infrastructure framework 502 as discussed in greater detail below in reference to FIG. 5.

A pre-lock consistent with one or more implementations of the current subject matter can include at 404 restricting access to transactions that relate to the affected one or more parts of the database system. For new transactions, for example those transactions commencing after the setting of the pre-lock, data associated with an affected part of the database system is set to read-only. Completion of in-progress transactions, for example those transactions that were started but not completed prior to the setting of the pre-lock, can be allowed. The allowing of completion of in-progress transactions, can include maintaining an availability for data to be written to the one or more pre-locked parts during a grace period lasting for a pre-defined duration. In one illustrative example, the pre-defined duration can be a pre-set tie such as 15 minutes. Alternatively, a pre-defined duration of the grace period can be determined statically (e.g. at design time) or dynamically (e.g. at run time based on data or some subset of data in the database system), for example based on an average time during which all or some transactions in the database system are completed.

After the grace period expires, a final lock is set on the one or more affected parts of the database system at 406 while continuing to leave the at least one unaffected part of the database system available for productive use. The final lock includes write locks on the one or more affected parts of the database system. Once the data are migrated and activities relating to the lifecycle management event have been performed (for example with additional downtime), the final lock can be removed at 410 such that the database management system can be used productively again. At 412, a second part of the database system that is neither affected by the lifecycle management event nor dependent upon the affected part of the database system can remain in productive use throughout the activities relating to the lifecycle management event.

Some implementations can include features that can be better understood with reference to the system architecture 500 shown in FIG. 5. Application code can be modeled and implemented as business objects in some implementations of the current subject matter. A central infrastructure framework 502 (for example an enterprise service framework or “ESF”), which can also be referred to as an object relational mapping (ORM) framework, can provide write access to a repository 116 or other application data persistence and can be the central clearinghouse via which data structure modifications and other changes to one or more parts of a database system are handled. The use of a central infrastructure framework 502 can, in some implementations, allow a central disablement of object changes. For usability improvement, user interfaces referring to locked business objects can be switched to read-only fields. A central business object lock can optionally be used for all changes within one session.

External consumer systems 504, which can optionally include one or more of an application to X-terminal (A2X) system 506, a business to business (B2B) system 510, an application to application (A2A) system 512, or the like, can interact with a computing system 102 that can include one or more application servers executing the central infrastructure framework 502, which can include functionality similar to a lifecycle event management event module 112. Interactions between the one or more external consumer systems 504 and the computing system 102 can occur via one or more of synchronous and asynchronous messages. Message payloads of these messages can be parsed, processed, routed, etc. via one or more inbound process agents 514 at the computing system. An inbound process agent 514 can be a type-specific inbound process agent 516 configured to communicate with one or more specific types of external consumer system 504, or can optionally be a generic inbound process agent 520. In general, an inbound process agent can initiate execution of a feature or features of a business process (for example a business process step, a sub-process, a series of business process steps, or the like) that are associated with a message payload received from one or more of an external consumer system 504, a local process integration infrastructure 522 (e.g. a mechanism for handling messaging with application parts which are only loosely coupled via asynchronous intra system messages), or the like. The business process feature can optionally include creating, updating, or otherwise modifying, etc. one or more instances of one or more business objects.

In the diagram 500 of FIG. 5, a first business object 524 can be affected by the lifecycle management event. This business object 524 can be subject to the pre-locking and final locking procedures discussed above. In addition, other data structures or parts of the database system that are not directly impacted by the lifecycle management event but that have a dependency upon or that are dependent upon an affected part of the database system can also be subject to the pre-locking and locking procedures. For example, as shown in FIG. 5, a second business object 526 that is dependent upon the first business object 524 can also be pre-locked and then locked consistent with features of implementations of the current subject matter. However, a third business object 530 that is not dependent upon the affected first business object 524 is not subject to any pre-locking or final locking and is allowed to remain in productive use throughout the lifecycle management event.

A first user interface 532 supported by either or both of the first business object (e.g. a part of the database system affected by the lifecycle management event) and the second business object (e.g. a part of the database system not affected by the lifecycle management event but dependent upon a part of the database system that is affected) can be subject to pre-locking and then to final locking. However, a second user interface 534 that is supported by the third business object 530 (e.g. a part of the database system that neither affected by the lifecycle management event nor dependent upon a part of the database system that is affected by the lifecycle management event) can continue in productive use throughout the activities of the lifecycle management event. Clients or users 536 accessing the first user interface 532 can continue to use the features of the first user interface 532 in a read-only mode at least during the grace period, while other clients or users 540 accessing the second user interface 534 can continue to use the features of the second user interface 534 throughout the lifecycle management event.

On a database level, modifications on the table level are allowed during the pre-lock procedure. However, a “freeze trigger,” can be implemented for the user interface 532 by a database interface 542. In the final lock mode, the database system can operate according to one or more of the following features. The user interface framework can identify which screens and which data are read-only. These screens can be set to not offer fields to insert new data or change existing data. Rather, only search fields or other fields that can accept input without affecting data in the database (e.g. repository 116) can be set to accept input. The central infrastructure framework 502 can identify which data areas are read-only. For these areas the central infrastructure framework 502 can enact a save check method and a pre-save check method that can return a message indicating that saving is not currently possible.

The central infrastructure framework 502 can return an exception if a WebService or inbound agent tries to update a locked business object or other part of the database system. In this case, the WebService or inbound agent can return send a standard http error code to the caller of the WebService. Asynchronous messages can be stored in an inbound queue and marked as temporarily not processable. The database or repository 116 can return an error if an attempt to write data into the locked area is performed despite the user interface and transaction locks. This process can be part of an emergency mechanism to ensure 100% read-only of the database tables. During normal operation and software according to typical lifecycle management event guidelines, this should not occur. However, in an exceptional case in which it does occur, this mechanism ensures still no data can be written, but there will be an error message.

A data migration procedure consistent with implementations of the current subject matter can include one or more of the following features. The metadata indicating which data areas are to be migrated can be deployed into the database or repository 116 or otherwise deployed into the central infrastructure framework 502 or the database interface 542. A pre-lock as discussed above can be set for this data area. The final lock can be set after a grace period. A new persistency (e.g. a new repository) 546 can created, separately from the currently active persistency 116. Data migration programs can then be executed such that data are copied from the currently active persistency, which is now read-only, to the new persistency 544 associated with, for example, an upgrade shadow system 546 having a second instance of a database interface 550. The copying can include both structure and semantic conversions. During a short downtime period in which the entire system 102 can be removed from productive use temporarily, the new persistency 544 and the upgrade system 546 can be transitioned to an active state. The original persistency 116 can then be deleted, invalidated, or otherwise moved to an area without access for compliance or archiving reasons. The new persistency 544 can be moved in, and the locks can be released such that the application server of the shadow system 546 can resume operation normally.

A set of lifecycle management metadata can be provided as part of a lifecycle management event (e.g. a software deployment such as an upgrade or new software, a system copying or migration event, or the like). The lifecycle management metadata can enable a selective downtime procedure to operate efficiently and can, in various implementations, include one or more of a list of database tables affected by the lifecycle management event (for example for locking on the database level), a list of business objects affected by the lifecycle management event (for example to assist the central infrastructure framework 502 in setting locks and also to set one or more fields on user interface associated with the affected business objects to read-only and to disables actions, buttons, or other user interface features that can cause a data change), a list of any inbound interfaces or inbound process agents 514 that are affected by the lifecycle management event. (for example for locking inbound message traffic).

User transactions that can result in changes to data structures or other entities such as business objects that are locked during a data migration can advantageously be blocked earlier than the actual lock is created for the affected one or more parts of the database system. In this manner, users who are running a change transaction or otherwise interacting with a feature that affects data in a data structure or other part of the database system (for example such as a business object) can have the chance to complete and save their work before the actual, final lock is created on the affected part or parts. For example, an application user interface 536 can check whether an affected business object is locked or pre-locked before starting a change transaction. A central infrastructure framework 502 can require that create, delete, or update interfaces can check whether the affected business object or other part of the database system is locked and if so can ignore the pre-locks.

Implementations of the current subject matter can provide one or more advantages. For example, executing some activities during a partial “read-only mode” of the system can reduce the downtime of a system required during deployment of software changes to a system. In an implementation, only selected parts or data areas of the system are set to read-only. End-users can continue using the system, mostly in its full scope. However, for some data areas, only read-only access is possible. The data change program can be run during “uptime.” The system can remain accessible to a large extent. The data change program can operate on data and has exclusive access (write). An approach consistent with implementations of the current subject matter can reduce the downtime for a deployment and can also reduce the risk of failure during downtime and long downtime upon failure. Larger parts of the deployment procedure for software changes (like the deployment of new data) can be completed during system uptime. Such an approach can be used to deploy software and configuration changes to application servers having data, configuration and software stored in the same database.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer program product comprising a non-transitory machine-readable medium storing instructions that, when executed by at least one programmable processor, cause the at least one programmable processor to perform operations comprising:
setting, as part of an initiation of a lifecycle management event to a database system running on at least one application server, a pre-lock for a part of the database system affected by the lifecycle management event;
restricting, as part of the pre-lock, access to transactions relating to the affected part of the database system while leaving at least one unaffected part of the database system available for productive use, the restricting comprising making data displayed in a user interface and associated with the affected part of the database system read-only with respect to new transactions commencing after the setting of the pre-lock, and allowing completion of one or more in-progress transactions commenced but not completed prior to the setting of the pre-lock, the allowing occurring during a grace period of a pre-defined duration;
setting a final lock on the affected part of the database system after expiration of the grace period, the final lock comprising a write lock on the affected part of the database system while continuing to leave the at least one unaffected part of the database system available for productive use; and
removing, after completion of activities of the lifecycle event that relate to the affected part of the database system, the pre-lock and the final lock such that productive use of the database system can resume.

2. A computer product as in claim 1, wherein the operations further comprise: maintaining a second part of the database system that is neither affected by the lifecycle management event nor dependent on the affected part in productive use throughout the activities of the lifecycle event.

3. A computer product as in claim 1, wherein the operations further comprise: checking whether an affected business object is locked or pre-locked before starting a change transaction.

4. A computer product as in claim 1, wherein the allowing completion of the one or more in-progress transactions comprises maintaining an availability for data to be written to the pre-locked part during the grace period lasting for the pre-defined duration.

5. A computer product as in claim 4, wherein the pre-defined duration comprises at least one of a statically determined value set at design time, a first dynamically set value determined at run time based on at least a subset of data in the database system, and a second dynamically set value determined at run time based on an average time during which transactions in the database system are completed.

6. A computer product as in claim 1, wherein the operations further comprise: prompting a user to complete and save his or her work before the final lock is created on the affected part of the database system.

7. A system comprising:
at least one programmable processor; and
a machine-readable medium storing instructions that, when executed by the at least one processor, cause the at least one programmable processor to perform operations comprising:
setting, as part of an initiation of a lifecycle management event to a database system running on at least one application server, a pre-lock for a part of the database system affected by the lifecycle management event;
restricting, as part of the pre-lock, access to transactions relating to the affected part of the database system while leaving at least one unaffected part of the database system available for productive use, the restricting comprising making data displayed in a user interface and associated with the affected part of the database system read-only with respect to new transactions commencing after the setting of the pre-lock, and allowing completion of one or more in-progress transactions commenced but not completed prior to the setting of the pre-lock, the allowing occurring during a grace period of a pre-defined duration;
setting a final lock on the affected part of the database system after expiration of the grace period, the final lock comprising a write lock on the affected part of the database system while continuing to leave the at least one unaffected part of the database system available for productive use; and
removing, after completion of activities of the lifecycle event that relate to the affected part of the database system, the pre-lock and the final lock such that productive use of the database system can resume.

8. A system as in claim 7, wherein the operations further comprise: maintaining a second part of the database system that is neither affected by the lifecycle management event nor dependent on the affected part in productive use throughout the activities of the lifecycle event.

9. A system as in claim 7, wherein the operations further comprise: checking whether an affected business object is locked or pre-locked before starting a change transaction.

10. A system as in claim 7, wherein the allowing completion of the one or more in-progress transactions comprises maintaining an availability for data to be written to the pre-locked part during the grace period lasting for the pre-defined duration.

11. A system as in claim 10, wherein the pre-defined duration comprises at least one of a statically determined value set at design time, a first dynamically set value determined at run time based on at least a subset of data in the database system, and a second dynamically set value determined at run time based on an average time during which transactions in the database system are completed.

12. A system as in claim 7, wherein the operations further comprise: prompting a user to complete and save his or her work before the final lock is created on the affected part of the database system.

13. A computer-implemented method comprising:
setting, as part of an initiation of a lifecycle management event to a database system running on at least one application server, a pre-lock for a part of the database system affected by the lifecycle management event;
restricting, as part of the pre-lock, access to transactions relating to the affected part of the database system while leaving at least one unaffected part of the database system available for productive use, the restricting comprising making data displayed in a user interface and associated with the affected part of the database system read-only with respect to new transactions commencing after the setting of the pre-lock, and allowing completion of one or more in-progress transactions commenced but not completed prior to the setting of the pre-lock, the allowing occurring during a grace period of a pre-defined duration;
setting a final lock on the affected part of the database system after expiration of the grace period, the final lock comprising a write lock on the affected part of the database system while continuing to leave the at least one unaffected part of the database system available for productive use; and
removing, after completion of activities of the lifecycle event that relate to the affected part of the database system, the pre-lock and the final lock such that productive use of the database system can resume.

14. A computer-implemented method as in claim 13, further comprising: maintaining a second part of the database system that is neither affected by the lifecycle management event nor dependent on the affected part in productive use throughout the activities of the lifecycle event.

15. A computer-implemented method as in claim 13, further comprising: checking whether an affected business object is locked or pre-locked before starting a change transaction.

16. A computer-implemented method as in claim 13, wherein the allowing completion of the one or more in-progress transactions comprises maintaining an availability for data to be written to the pre-locked part during the grace period lasting for the pre-defined duration.

17. A computer-implemented method as in claim 16, wherein the pre-defined duration comprises at least one of a statically determined value set at design time, a first dynamically set value determined at run time based on at least a subset of data in the database system, and a second dynamically set value determined at run time based on an average time during which transactions in the database system are completed.

18. A computer-implemented method as in claim 13, further comprising: prompting a user to complete and save his or her work before the final lock is created on the affected part of the database system.

19. A computer-implemented method as in claim 13, wherein at least one of the setting of the pre-lock, the restricting, the setting of the final lock, and the removing is performed by at least one programmable processor.

20. A computer program product as in claim 1, wherein the lifecycle management event comprises at least one of an import, an upgrade, and a hot fix; and the part of the database system affected by the lifecycle management event comprises some but not all tables in the database system.
